(19) United States
(12) Patent Application Publication
(10) Pub. No.: US 2008/0251462 A1
(43) Pub. Date: Oct. 16, 2008

(54) Decontamination Process and System

(75) Inventor: Rupert Bevan, Bath (GB)

Correspondence Address: PATREA L. PABST;PABST PATENT GROUP LLP, 400 COLONY SQUARE, SUITE 1200, 1201 PEACHTREE STREET, ATLANTA, GA, 30361, US

(73) Assignee: Zander Corporation Ltd.

(21) Appl. No.: 12/067,084

(22) PCT Filed: Sep. 14, 2006
(86) PCT No.: PCT/GB2006/003411

§ 371 Date: Jun. 13, 2008

(30) Foreign Application Priority Data
Sep. 15, 2005 (GB) 0518887.5

(51) Int. Cl. C02F 1/42; B01J 20/22; C02F 101/20

(52) U.S. Cl. 210/680; 210/679; 210/502.1; 210/335; 210/359

(57) ABSTRACT

The present invention provides a decontamination process comprising the step of contacting a aqueous solution containing a pollutant or contaminant with a decontaminating agent, wherein the decontaminating agent is sapropel. The present invention also provides a decontamination system (110).

The present invention relates to a decontamination process. In particular, the present invention relates to a decontamination process for removing pollutants or contaminants, such as heavy metals, from contaminated areas of land or water. More particularly, the present invention relates to a decontamination process, which involves the use of sapropel to remove pollutants or contaminants, such as heavy metals, from an aqueous solution containing such contaminants. The invention also relates to a decontamination system for use in the process of the present invention.

Industrialisation is one of the major causes of wide scale contamination of land and water with pollutants or contaminants, such as heavy metals, namely, polluting metal ions that are persistent and potentially toxic to the environment and which include, but which are not limited to, aluminium, cadmium, lead, copper, nickel, chrome, mercury, and zinc.

As contaminants, heavy metals usually occur as cations of chloride or nitrate salts, which dissolve into the ground water and subsequently percolate through the geosphere and are inevitably absorbed into the biosphere. As will be appreciated, this can lead to serious metabolic poisoning of both humans and animals if water, and plants which have absorbed such contaminants are ingested

It has been conservatively estimated that in the UK alone there are at least 75,000 contaminated sites covering nearly 80,000 hectares.

Excavation is by far the commonest method of treating or decontaminating contaminated land. Although excavation may deal with the immediate problem for a contaminated site, the land removed has obviously to be deposited somewhere in its contaminated condition and, as such, it will be appreciated that the process of excavation itself merely transfers the problem elsewhere.

In the case of water, which contains contaminants, it is known to expose or pass the water through crushed limestone filters. This raises the pH of the contaminated water and precipitates the “contaminant” cations therefrom. Processes of this type are primarily used to treat see pages from mining operations and power station emissions; however, the major disadvantage is the problem with disposal of spent material, from which heavy metals are easily leached back into the biosphere.

It is also known to treat aqueous solutions of contaminants, such as heavy metals, with decontaminating agents such as activated charcoal, zeolites, and flocculants, such as polyacrylamide; however, such decontaminating agents are either costly to produce and/or costly to process subsequent to use i.e. once spent.

Therefore, in the light of the above, it is evident that there is a need to provide a decontaminating agent and a decontamination process, which at least addresses some of the problems of the prior art agents and processes identified above. In particular, it is an object of the present invention to provide a decontaminating agent and process that can reduce the presence of contaminants, such as inorganic pollutants, for example heavy metals, in particular heavy metal salts, and organic pollutants, such as PCB's, from a toxic to a biotolerant level.

Sapropel is a clay-like material, which is known as a source material for oil and natural gas. The term, sapropel, is derived from the Greek sapros, meaning “decay” and pelos meaning “sand”, and denotes a range of marine and lacustrine sediments containing organic and inorganic components. Sapropels range from the black organic oozes associated with the Silurian rock formations to variously coloured Holocene deposits.

Tabulated below is a list of countries and regions of the world where sapropel is reported to be found, together with a description of geological age.

Table 1

TABLE 1
Countries and regions of the world where sapropel
is reported to be found, together with description
of geological age. Source: Andersons (1996).

| Continent | Type of deposit |
|---|---|
| Northern Europe: | |
| Finland | Lacustrine Quaternary |
| Sweden | ″ |
| Estonia | ″ |
| Latvia | ″ |
| Lithuania | ″ |
| Denmark | ″ |
| Netherlands | ″ |
| Baltic Sea | Marine Quaternary |
| Central Europe: | |
| Czech Republic | Lacustrune Quarternary |
| East Germany | ″ |
| Poland | ″ |
| Northern Italy | ″ |
| Romania | ″ |
| Southern Europe: | |
| Mediterranean Sea | Marine Silurian - Quarternary |
| Black Sea region | ″ |
| Eastern Europe: | |
| Belarus | Lacustrine Quaternary |
| Ukraine | ″ |
| Russia | |
| Karelia | ″ |
| Omsk | ″ |
| Yakutsk | ″ |
| Nisny Novgorod | ″ |
| Tomsk | ″ |
| The USA: | |
| Arkansas | Lacustrine Quaternary |
| Florida | ″ |
| Minnesota | ″ |
| Nebraska | ″ |
| Wisconsin | ″ |
| Canada | Lacustrine Quaternary |
| South America: | |
| Venezuelan coast | Marine Quarternary |
| Australia: | |
| Lake Cooroong | Lacustrine Quarternary (Sapropel |
| | precipitated as supernatent wax) |
| Africa: | |
| Namibia | Lacustrine Quaternary |
| | (Sapropel precipitated as supernatent wax) |

Deposits of sapropel are mainly associated with sub-boreal lakes of Northern Europe, Siberia, Canada and the northern states of the U.S.A. Within Europe there are concentrations of sapropel-rich lakes in Karelia, Estonia, Latvia, Lithuania, Poland the Czech Republic. Smaller amounts are reported to exist in Denmark, Finland, Sweden, the Netherlands, northern Italy and eastern parts of Germany. Extensive deposits are also found in Ukraine, Belarus and the Russian Federation, in particular, in the “Golden Ring”; namely, the region between Moscow and St. Petersburg in north-west Russia, and Siberia.

As will be appreciated, not all sapropels are found as lake deposits. They may have their origin in peat formed in subsequent layers of vegetation. For example, sapropel from the Lake Sakhtysh region of north-west Russia is mined from beneath dry peat land.

Marine sapropels can also occur which are also Holocene. They are associated with the seas bordering arid regions, such as Namibia and the Sierra Nevada of Venezuela, and the eastern Mediterranean and Black Sea in Europe.

In the European regions, sapropels have been reported to form at a rate of 1 mm per annum. The organic components of sapropel accumulate in micro-laminations from a continuous rain of organic debris originating in vast reed beds bordering the lakes, and is therefore autochthonous, i.e. originating from within the area of the lake. The inorganic component of sapropel is probably allochtonous, i.e. originating from outside the lake, but the presence of certain minerals such as calcium, magnesium and sulphur may originate from autochthonous organic sources.

Many sapropels are almost white-to-cream coloured. This reflects the amount of organic matter contained therein. As will be appreciated, as the organic component within the sapropel increases it will assume a darker colour; some sapropels are jet black.

Sapropels exhibit varying alkalinity. In this connection, sapropels having a pH greater than 7 are termed “lime-sapropels” and are usually characterised by the presence of several species of snails.

Sapropel can form in marine environments, as well as in freshwater lakes.

In marine environments, where the sea floor is too deep to allow oxygen to remain dissolved, sulphur-rich water acts as a reducing agent and provides an environment where organic debris can form sapropel. The sulphur itself is derived from the partial decomposition of plant and animal matter. In the areas of the sea beds where deposits of sapropel are found, the adjacent landmass is usually arid and well-leached of plant-growth supporting minerals. This may result in a correspondingly high supply of nutrients supporting a rich diversity of biota off the coast.

Typically, sapropel-rich lakes are situated on low-lying land. Generally, the lake bedrock is relatively insoluble and the lakeside soils tend to be podzol, from which nutrients are easily leached. The lakes themselves become sumps for these mobilised mineral salts, which are assimilated by reed beds that act as water-purifying agents. Sapropel forms on the lake floor in much the same way as peat forms on a raised or blanket bog. The organic compound is derived from limnic (surface) vegetation, in particular, reeds. As these herbaceous plants pass through their annual cycle of growth and decay, they give rise to a continuous stream of organic waste material that accumulates on the lakebed. Here decomposition is continued in the form of digestion of the lignified tissues. Sulphur from protein bonding is liberated in the form of hydrogen sulphide gas, which combines with dissolved oxygen to form soluble sulphurous acid. In a typical sapropel lake, there is little replacement oxygen as the water tends to be stagnant. After a while all the available oxygen is used up such that decomposition slows down and eventually stops altogether. Thereafter, the digestion of organic material becomes anaerobically controlled, giving rise to chemical reductions and the precipitation of certain minerals.

Some lakes have been accumulating sapropel undisturbed for over 10,000 years. In some places, deposits of sapropel have displaced nearly all of the water. For example, Lake Zebrus in Latvia has approximately a half metre depth of water remaining.

Not all sapropel deposits are found in the lacustrine environment. For example, in the Lake Sakhtysh region of northern Russia, water has receded in recent time and some of the former lake land has undergone a succession to moss or reed beds, with a layer of peat formed above the sapropel deposit.

In the past, sapropel has been utilised as a soil conditioner to render the podsols of Russia more retentive. In this connection, the use of sapropel as a fertiliser has been achieved by mixing it with farm slurries and manures to improve its nitrogen content. In addition, due to its mineral content, sapropel has also been utilised in some countries as a supplement to animal feed.

In a first aspect of the present invention there is provided a decontamination process comprising the step of contacting a pollutant or contaminant, the pollutant or contaminant preferably within an aqueous solution, with a decontaminating agent, wherein the decontaminating agent is sapropel.

Our investigations have established that sapropel has a high cation exchange property and, as such, is capable of adsorbing contaminants, such as heavy metals, precipitated metals and non-metals, such as chrome, beryllium and arsenic and oil-based water dispersable liquids such as polycyclic aromatic hydrocarbons (PAHs) and polychlorobiphenyls (PCB's). In addition, as a naturally occurring resource, which is constantly replacing itself, it is relatively cheap to extract for use. Furthermore, and since it is combustible, it, unlike known decontaminating agents, is relatively easy to dispose of subsequent to use i.e. once spent.

In a preferred embodiment, the sapropel has a water content, that is, when compared to its water content on extraction, of about 90% or below for absorption of organic residues, preferably about 80% or below, more preferably 80% or below, even more if very dry, further preferably about 40% or below for adsorption of metal ions. As will be appreciated, the water content of sapropel can be measured by taking a 10 g sample of sapropel and drying same to constant mass, that is, up to the point where there is no further loss of weight. The difference represents the water lost and is expressed as a percentage of the mass of water of a saturated sample.

Further preferably, the sapropel is dried to 40% moisture content and any cohesive lumps ground prior to use as a decontaminating agent.

Further preferably, the aqueous solution containing the pollutant or contaminant is passed through at least one filter which includes sapropel, preferably two sapropel containing filters, more preferably three sapropel containing filters. Further preferably, the pollutant or contaminant is passed sequentially through at least one filter including sapropel, preferably at least two filters, preferably at least three filters.

Advantageously, the aqueous solution containing the pollutant or contaminant is passed through at least one layer of sapropel, which may be an intermittent layer or a continuous layer of sapropel. Examples of embodiments would be as a reed bed or a lagoon.

Further preferably, the aqueous solution containing the pollutant or contaminant is passed through the at least one filter which includes sapropel or the at least one layer including sapropel in such a manner that the sapropel becomes agitated and dispersed within the aqueous solution. This agitation enhances contact between the sapropel and the pollutants or contaminants being carried by the aqueous solution. One preferred way for achieving this agitation involves reverse flowing the aqueous solution through the at least one filter or the at least one layer of sapropel. This will agitate or stir up the sapropel thereby enhancing contact between the sapropel and the contaminants or pollutants thereby speeding contaminant or pollutant uptake eg uptake of unwanted metals.

Advantageously, the sapropel is agitated prior to, or on contact with, the aqueous solution such that absorption of the contaminants or pollutants is enhanced. As will be appreciated, this disperses the sapropel within the aqueous solution and enhances exposure of the adsorbing surfaces of the sapropel with the contaminants or pollutants.

Preferably, the sapropel has a water content of 30-40% and the sapropel is agitated or stirred up either before or on contact with the contaminants or pollutants. This maximises the opportunity for collisions between the heavy metal ions and the sapropel matrix, reducing the time for ion uptake by at least 85%.

Advantageously, when the contaminant includes heavy metal salts, for example, heavy metals salts of zinc, aluminium, copper, cadmium, lead, mercury, thallium and silver, the sapropel has a water content of 60% or below, that is, when compared to its water holding capacity at extraction. At this point, the sapropel is wet enough to disperse in water, but dry enough to hold its moisture even when squeezed.

Further preferably, the aqueous solution containing the pollutant or contaminant has a pH falling within the range of 2.5 to 9.5. In this connection, if required, a buffer could be added to maintain a pH falling within the aforementioned range.

Advantageously, the process further includes the step of removing any surfactants or other coating agents i.e. other agents which can form an impenetrable barrier between the sapropel and the contaminant carrying liquid, for example, oils and detergents.

Advantageously, the sapropel to be used in the present process is mixed with a spacer, such as shredded wood bark. This decreases the density of the sapropel and, as such, enables the aqueous solution to flow freely through the sapropel thereby facilitating the contact between the pollutant or contaminant with the sapropel.

Advantageously, when the pollutant or contaminant includes fine particles of precipitated metals and non-metals such as chrome, beryllium and arsenic, the sapropel has a water content of 60% or more, that is, when compared to its water content on extraction.

Further preferably, where the contaminant includes oil based water-dispersible liquids, such as soluble polycyclic aromatic hydrocarbons (PAHs) and polychlorobiphenyls (PCBs), the sapropel has a water content ranging between 80% to 95%.

To test the properties of sapropel as a decontaminant of aqueous solutions containing heavy metal salts, the following investigations were conducted.

A) The Properties of Sapropel as a Decontaminant of Aqueous Solutions of Heavy Metal Salts

Samples of black and white sapropel, either as found, or having a water content of 80% or 15% were weighed out in the quantities listed in Table 2 below. The samples used were fresh black and white sapropel, and black and white sapropel dried to 15% water content. Black, composted sapropel, having a water content of 80% was also tested. To each sample 10 ml or 20 ml of a 910 ppm solution of lead nitrate was added and the admixture was thoroughly stirred with a glass rod for one minute. Each mixture was left to stand for a further five minutes, before being filtered through a standard filter paper. The amount of lead remaining in the filtrate was determined using an atomic absorption spectrophotometer.

TABLE 2
Samples of sapropel prepared for treatment with
20 ml lead nitrate solution n = 3.

| Experimental design | Sapropel (g) |
|---|---|
| Test solution | 0 |
| A. White sapropel as found. | 5 |
| B. White sapropel as found. | 10 |
| C. White sapropel at 15% water content. | 1 |
| D. White sapropel at 15% water content. | 2 |
| E. Black sapropel as found. | 5 |
| F. Black sapropel as found. | 10 |
| G. Black sapropel at 15% water content. | 1 |
| H. Black sapropel at 15% water content. | 2 |
| I. Black sapropel at 80% water content. | 1 |
| J. Black sapropel at 80% water content. | 2 |
| K. Black sapropel at 80% water content. | 5 |
| L. Black sapropel at 80% water content. | 10 |

### Results

The results of our investigations are tabulated in Table 3 below:

| | Sapropel: g | Lead in | Lead |
|---|---|---|---|
| | in 20 ml | filtrate: Mean | Removed |
| Experimental Design | Pb(No₃)₂ | values (ppm) | (%) |
| Test Solution | 0 | 910 | 0.00 |
| A. White sapropel as found. | 5 | 196 | 78.46 |
| B. White sapropel as found. | 10 | 7.7 | 99.15 |
| C. White sapropel at 15% water content. | 1 | 315 | 65.38 |
| D. White sapropel at 15% water content. | 2 | 56 | 93.84 |
| E. Black sapropel as found. | 5 | 119 | 86.92 |
| F. Black sapropel as found. | 10 | 3.4 | 99.62 |
| G. Black sapropel at 15% water content. | 1 | 111 | 87.8 |
| H. Black sapropel at 15% water content. | 2 | 8.1 | 99.11 |
| I. Black sapropel at 80% water content. | 1 | 45.8 | 95 |
| J. Black sapropel at 80% water content. | 2 | 187 | 79.45 |
| K. Black sapropel at 80% water content. | 5 | 6.8 | 99.25 |
| L. Black sapropel at 80% water content. | 10 | 2.3 | 99.74 |

As tabulated in Table 3 above, it is evident that all types of sapropel removed lead from the solution with which it was contacted. On closer examination, dry, white sapropel having a ratio of 1:20 (sapropel to solution) removed the lowest amount of lead (see C), whereas black sapropel having a water content of 80% and mixed at a ratio of 10:20 (sapropel to solution) removed the highest amount of lead from the solution (see L). All other designs ranged between these two parameters, but high percentages were achieved at other 2:20 ratios (see D and H for example). Even at a ratio of 1:20 the organic sapropel (see K) was seen to produced a high result. Where ratios of sapropel to lead nitrate solution were high, differences between the various types of sapropel were notable (see results B, F and L), with the white type removing 99.15% of the lead, whilst the black type, having a water content of 80%, removed 79.45%.

B) The Effect of Water Content on the Decontaminating Properties of Sapropel

To investigate the effect of the water content on the decontaminating property or adsorbency properties of sapropel, we also conducted the following investigation.

Samples of black sapropel having a different moisture or water content (eg 0%, 10%, 20%, 30%, 40%, 50%, 60%, 70%, 80%, 90% and 100%) were selected and weighed out into 5 g amounts. Three replicates were prepared for each level of water content and were mixed with a 0.5 molar lead nitrate solution, shaken and filtered, as before. Once again, the resultant filtrates were subjected to atomic absorption spectrophotometry and the resulting data recorded.

### Results:

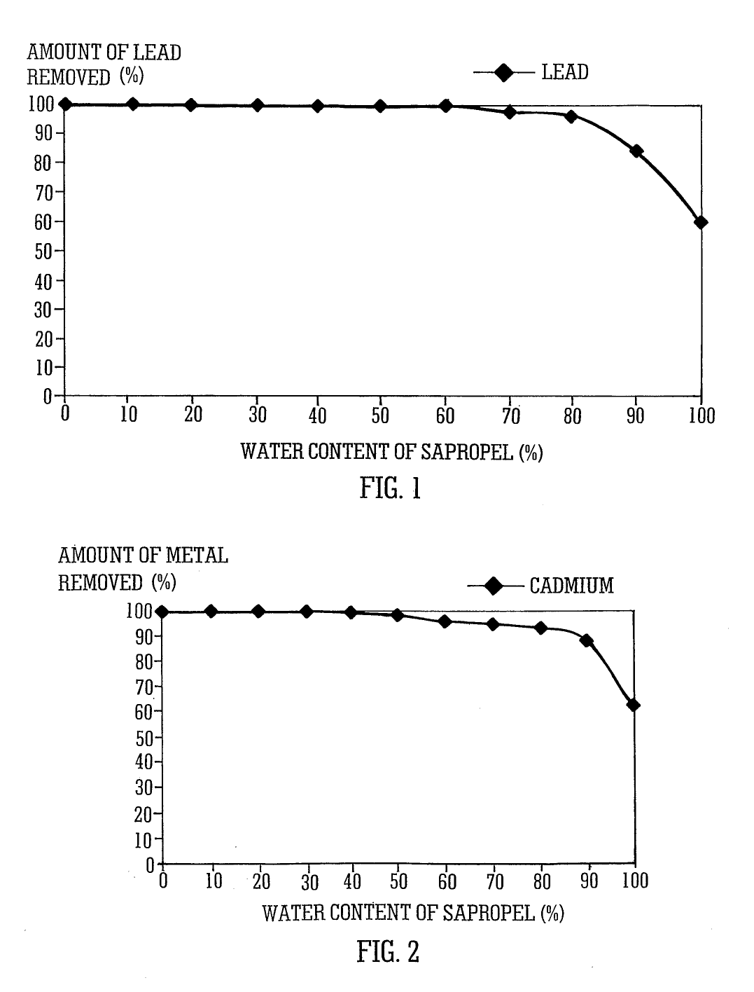

As illustrated in FIGS. 1 and 2, it is noted that at a 100% water content, i.e. saturation, the uptake of lead amounted to approximately 60% for both lead and cadmium. As the water content of sapropel decreased to 90%, the uptake of heavy metal began to increase. In samples having a water content of 80%, it was observed that the uptake in each case was over 90%. In addition, it was observed that nearly all the metal was removed by the samples containing a water content of 70% or below.

This clearly exemplifies that the lower the water content of sapropel, the greater its adsorptive capacity to remove heavy metal contaminants.

C) Comparison of Uptake of Other Cations

In order to investigate the adsorptive properties of sapropel in relation to other cations, 0.5 molar solutions of cadmium sulphate, zinc sulphate and aluminium sulphate were prepared, and 2 g samples of ground black sapropel, having a water content of 15%, were added to 10 ml, 20 ml and 30 ml amounts of the solutions respectively. Three replicates were made of each design and the mixtures were shaken for thirty seconds and then allowed to settle for five minutes. The resultant filtrates were then tested for metals using atomic absorption spectrophotometer, as before.

### Results:

The results of our above investigation are tabulated below in Table 4.

With reference to Table 4 it is evident that the highest percentage of aluminium is removed where the ratio of sapropel to solution is 1:10, with a decrease in uptake noticed at higher volumes of solution. The same pattern is observed for the uptake of zinc.

TABLE 4
Uptake of metal ions from three concentrations
of their salts by sapropel. n = 3

| | Concentration | | | |
|---|---|---|---|---|
| | original | | Cations | Metal |
| | solution | Sapropel/solution | in filtrate | removed |
| Cation | (ppm) | ratio (g ml⁻¹) | (ppm) | (%) |
| Aluminium | 690 | 1/10 | 95 | 86.23 |
| Aluminium | 690 | 1/20 | 218 | 68.41 |
| Aluminium | 690 | 1/30 | 540 | 21.74 |
| Zinc | 2020 | 1/10 | 1090 | 46.03 |
| Zinc | 2020 | 1/20 | 1790 | 11.38 |
| Zinc | 2020 | 1/30 | 1930 | 4.46 |

It was found subsequently that if salt solutions were left in contact with sapropel for 25 hours, the uptake of ions approached 100% in all cases.

D) Comparison of Sapropel with Other Decontaminants

In order to compare the absorptive properties of sapropel with other decontaminants, approximately 20 g of activated charcoal, powdered Fuller's earth were obtained from the research laboratories of Dera Demil (Porton Down, Wiltshire), 20 g sphagnum moss peat from a local garden centre and 10 g fresh sphagnum moss from laboratory cultures at BSUC. 10 ml samples of 0.5 molar solution of lead nitrate were then shaken with 0.5 g each of activated charcoal, Fuller's earth, moss peat, black sapropel and sphagnum moss. The sapropel used was the organic type having a 15% water content.

Three replicates were made for each experimental design and the mixtures shaken and allowed to settle for ten minutes. Once again, subsequent to filtration, the amount of lead in the filtrates was determined using atomic absorption spectrophotometry.

### Results:

The results of our investigations conducted with a view to comparing sapropel to other decontaminants, namely, activated charcoal and Fuller's earth are tabulated in Table 5 below.

TABLE 5
Uptake of lead by selected decontaminants. n = 3

| Decontaminant | Mean Uptake (%) |
|---|---|
| Sphagnum moss | 91.7 |
| Peat | 97.7 |
| Fuller's earth | 99.12 |
| Sapropel | 99.83 |
| Activated Charcoal | 99.86 |

With reference to Table 5, our results show that the efficiency of sapropel in removing lead ions from solution compares well with activated charcoal and Fuller's earth. In particular, sapropel removed as much lead (99.83%) as activated charcoal (99.86%), whilst Fuller's earth achieved 98.8% and peat 97.8%. Sphagnum moss removed the lowest amount, namely, 91.7%.

E) Reversal of Heavy Metal Uptake

In order to ascertain the nature of heavy metal uptake in sapropel, it was felt necessary to find out how much of the metal was held by each of a number of possible sites within the sapropel complex. A sequential digestion of the sediment was carried out along the precepts of (Tessier, A., Campbell P. G. C. and Bisson L. (1979) Sequential Extraction Procedure for the Specification of Particulate Trace Metals. Analytical Chemistry, Vol. 51, no. 7, June 1979). This involved the treatment of black and white sapropel with a range of chemicals that would release heavy metals attached to carbonates, iron/manganese complexes, organic complexes and exchange of salts. 1 g of contaminated sapropel was used and treated sequentially as follows:
1. Bound to molecules as exchangeable cations: 1 g samples of white and black sapropel contaminated with lead, cadmium and copper salts were leached with sodium acetate solution adjusted to a pH of 8.2 and agitated for one hour at room temperature. The leachates were separated from the solid matter by centrifugation for half an hour.
2. Bound to carbonates: The residues of (1) above were then leached with sodium acetate adjusted to pH 5 with ethanoic acid, and agitated for an hour. The liquid and solid components were subsequently separated by centrifugation, as before.
3. Bound to Fe/Mn oxides: The residues of (2) above were then treated with 0.04M hydroxy-ammonium chloride in 25% v/v ethanoic acid and agitated at approximately 96° C. for one hour. The resulting liquid and solid components were separated by centrifugation, as before.
4. Bound to organic complexes: To the residues of (3) above were then added 3 ml of 0.02M nitric acid and 5 ml of hydrogen peroxide solution, adjusted to a pH of 2 with nitric acid. The sample was then heated in a water bath to approximately 85° C. for three hours, with occasional agitation. On cooling, the samples were treated with ammonium acetate in nitric acid to prevent reabsorption of the extracted metals on to the oxidised sediment. Liquid and solid components were separated by centrifugation as before.
5. Residual: The hydrogen fluoride treatment prescribed by (Tessier, A., Campbell P. G. C. and Bisson L. (1979) Sequential Extraction Procedure for the Specification of Particulate Trace Metals. Analytical Chemistry, Vol. 51, no. 7, June 1979) was not feasible within the confines of Bath Spa University College. As a result, an estimation of residual heavy metal component was made by subtraction from the concentration of commencement of the sum of the specific metals obtained from the treatments above.

All leachates were tested for the presence of specific heavy metals by atomic absorption spectophotometry as before.

### Results:

Results of the sequential digestion of sapropel using the methods described by (Tessier et al.) are shown in Tables 5 and 6 below.

TABLE 5

| | | | | | LEAD | |
|---|---|---|---|---|---|---|
| | COPPER | | CADMIUM | | in | |
| TREATMENT | in filtrate | | in filtrate | | filtrate | |
| White sapropel | (ppm) | % | (ppm) | % | (ppm) | % |
| Concentration of metal | 960 | 100 | 920 | 100 | 774 | 100 |
| in test solution | | | | | | |
| Dried white sapropel | 160 | 16.7 | 160 | 17.4 | 7.93 | 1.1 |
| Bound to moelcules as | 90 | 9.3 | 90 | 9.8 | 54 | 7.1 |
| exchangeable cations | | | | | | |
| Bound to carbonates | 220 | 22.9 | 260 | 28.2 | 92 | 11.9 |
| Bound to FE/Mn | 220 | 22.9 | 140 | 15.2 | 128 | 16.5 |
| complexes | | | | | | |
| Bound to organic | 110 | 11.5 | 30 | 3.3 | 26 | 3.1 |
| complexes | | | | | | |
| Bound to inorganic | (160) | (16.7) | (240) | (26.1) | (466) | (60.2) |
| complexes | | | | | | |

TABLE 6

| | | | | | LEAD | |
|---|---|---|---|---|---|---|
| | COPPER | | CADMIUM | | in | |
| TREATMENT | in filtrate | | in filtrate | | filtrate | |
| Black sapropel | (ppm) | % | (ppm) | % | (ppm) | % |
| Concentration of metal | 960 | 100 | 920 | 100 | 774 | 100 |
| in test solution | | | | | | |
| Dried black sapropel | 60 | 6.2 | 290 | 31.5 | 2 | 0.3 |
| Bound to molecules as | 90 | 9.3 | 180 | 19.6 | 40 | 5.2 |
| exchangeable cations | | | | | | |
| Bound to carbonates | 290 | 30.2 | 240 | 26.0 | 260 | 33.6 |
| Bound to FE/Mn | 280 | 29.2 | 80 | 8.7 | 109 | 14.1 |
| complexes | | | | | | |
| Bound to organic | 180 | 18.8 | 70 | 7.6 | 283 | 36.5 |
| complexes | | | | | | |
| Bound to inorganic | (60) | (6.2) | (60) | (6.5) | (80) | (10.3) |
| complexes | | | | | | |

Tables 5 & 6: Analysis by sequential digestion of black and white sapropel (Tessier et al 1979) determining the sites within the sapropel complex where heavy metals are held. Results are from dried samples of black and white sapropel and brackets indicate a possible residual value where the digestion was not successfully carried out. n=3.

With reference to both Tables 5 and 6, it is evident that consistently high levels of three test metals were found to be bound to carbonate, whilst low levels were found in the exchangeable component of the sapropel matrix. This was common to both black and white samples, with the exception of cadmium, where a high proportion (19.6%) was found in black sapropel in this way. Binding to iron and manganese produced diverse results, with 29.2% of lead cations extracted from Fe/Mn matrices in black sapropel, whilst only 8.7% cadmium cations were extracted. Binding to organic complexes was much higher for lead in black sapropel (36.5%) than white (3.1%). A possible high percentage binding (60.2%) to inorganic complexes for lead in white sapropel is not reflected by the figure for black (10.3%) and generally the figures for organic binding are lower for the other two metals in black sapropel.

F) Determination of the Water Retentive Capacity of Sapropel

In order to determine the water retentive capacity of sapropel one-hundred samples of black sapropel, each weighing 100 g were placed on foil dishes in a closed room which was heated constantly at 20° C. and allowed to air dry. Ten samples were selected randomly and numbered. Every 48 hours, these were weighed and their masses recorded. The trial ran for 37 days. The samples were then oven dried at 100° C. to a constant mass. Recorded masses were collated graphically in order to determine also the water retentive properties of the samples. At each weigh-in, two additional samples were weighed and transferred to a refrigerator in a sealed PVC bag to prevent further water loss. Refrigerated samples were finely ground where necessary to facilitate further experimentation such as the determination of the effect of water content on the decontaminating property of sapropel.

### Results:

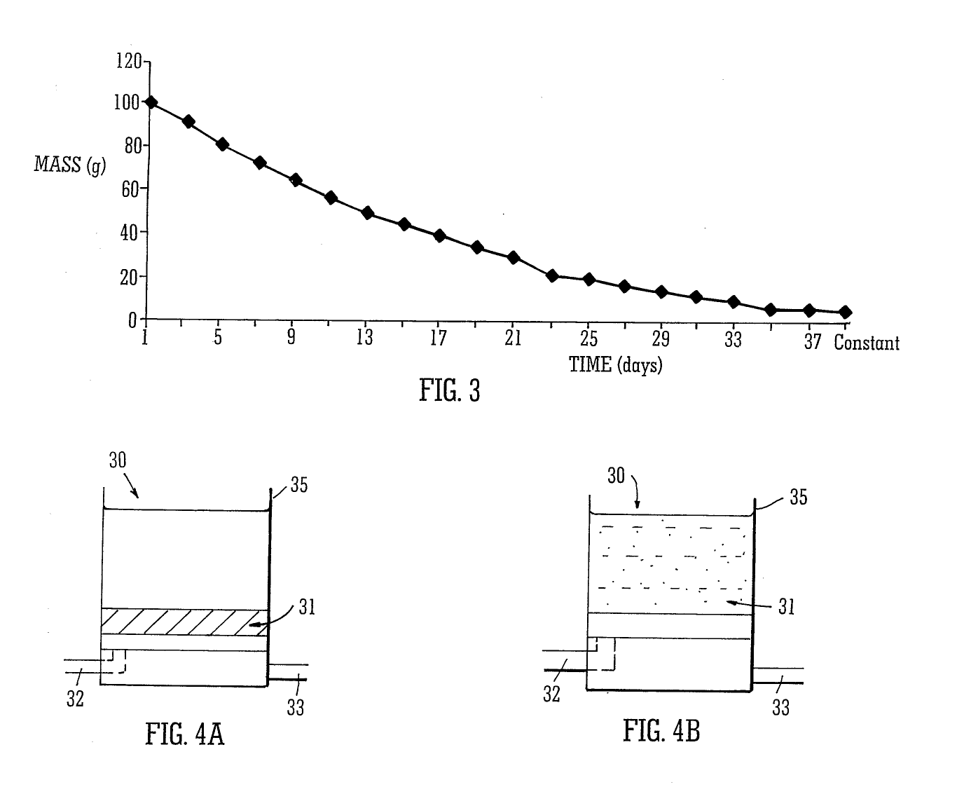

As shown by FIG. 3, water loss from sapropel at 20° C. reached its lowest point at 37 days. The rate of water loss from sapropel decreased with time. 50% of the water was lost in approximately thirteen days, whilst constant weight was achieved after 39 days. After day 37, the samples were oven dried to constant weight at which time they had lost 95.2% of their original mass.

Based on our results, it is postulated that as sapropel is allowed to dry out, the surface cations become increasingly electrically charged. At the same time, strong bonding occurs between opposing ions within the complex so that the reabsorption of water is effectively prevented. By grinding dry sapropel to a fine powder, we believe that many more sides are exposed and the sediment becomes an effective agent for cation exchange. An increase in the efficiency of the sediment to remove heavy metal ions is obviously correlated with decreasing water content. This is not restricted to lead; cadmium ions from cadmium sulphate are similarly removed and, in efficiency, matches lead.

In addition, and as a decontaminant, our investigations confirmed that sapropel compares well with other known decontaminants, particularly Fuller's earth, peat, sphagnum moss and activated charcoal.

Moreover, and as touched upon above, one of the other advantages of sapropel is that it is combustible, and as such, it, with its chemical challenge, can be disposed subsequent to use by burning it. Furthermore, and since its retentive properties increase as it dries out, the threat of secondary contamination is less likely. As a result, less complications will arise if contaminated sapropel is collected and stored for future disposal.

Another advantage of sapropel is that it has a higher relative density than other decontaminants, such and peat or sphagnum moss. As a result, a comparatively small volume is required to remove heavy metal cations in solution. Once again, as it dries out and shrinks, it becomes more efficient as the hydroxyl groups are lost and the material becomes increasingly electronegative.

Furthermore, the sequential digestion of sapropel showed that in both black and white samples, the heavy metal cations are bound to the complex in different ways. Both samples showed a high level of bonding to carbonate and manganese/iron complexes, whilst the bonding to organic complexes was less. This suggests that the bulk of the heavy metal is held tightly within the sapropel matrix, and the risk of the reversal of the bonding function is small.

Taking all factors into consideration, as we have done so in below in Table 6, it is possible to rank the decontaminants according to performance to relevant criteria using a five-point scale.

TABLE 6
Comparison of decontaminants. The substances listed have been ranked
on a scale of 1-5 where fulfilment of selected criteria is graded according
to individual response. 1 = poor; 2 = below average; 3 = average;
4 = above average; 5 = optimal response.

| | | Adsorp- | | Combus- | Environmen- | |
|---|---|---|---|---|---|---|
| Substance | Cost | tion | Handling | tibility | tal Impact | Total |
| Fuller's | 2 | 5 | 3 | 1 | 2 | 13 |
| earth | | | | | | |
| Peat | 4 | 4 | 3 | 5 | 1 | 17 |
| Activated | 1 | 5 | 2 | 4 | 4 | 16 |
| charcoal | | | | | | |
| Sphagnum | 1 | 3 | 4 | 5 | 1 | 15 |
| moss | | | | | | |
| Sapropel | 3 | 5 | 3 | 4 | 5 | 20 |

In another trial at the zinc smelter, assays were conducted in which sapropel was contacted with a heavy metal contaminated solution for 25 hours.

TABLE 7

| | FILTRATE | FILTRATE | | | |
|---|---|---|---|---|---|
| DESCRIPTION | WITHOUT | WITH | | | METAL |
| OF SAMPLE | SAPROPEL | SAPROPEL | | | CAPTURE |
| AND METAL | (PPM) | (PPM) | | | (%) |
| Waste support bund | 1.2 | 0.7 | nd | nd | 80.6 |
| Cu | | | | | |
| Compacted sediment | 7.3 | nd | nd | nd | 100 |
| As | | | | | |
| Compacted sediment | 0.9 | nd | nd | nd | 100 |
| Hg | | | | | |
| Compacted sediment | 196.3 | nd | nd | nd | 100 |
| Pb | | | | | |
| Zinc slag (all metals) | nd | nd | nd | nd | N/A |

As tabulated in Table 7, it is evident that sapropel removed most of the contaminant obtained from a zinc smelter from the solution. To this end, “nd” represents “none determined”.

Furthermore, in another assay, the results of which are tabulated below in Table 8, sapropel was contacted with contaminant containing waste water obtained from a lagoon at the smelter. As can be seen, it is evident that the majority of the contaminant was removed from the lagoon water by the sapropel.

TABLE 8
Samples of leachate waste water from a lagoon
at the Britannia Zinc smelter, Avonmouth, Bristol.
Sample protocol as for Table 7 above.

| | FILTRATE | FILTRATE | |
|---|---|---|---|
| | WITHOUT | WITH | METAL |
| DESCRIPTION OF | SAPROPEL | SAPROPEL | CAPTURE |
| SAMPLE AND METAL | (PPM) | (PPM) | (%) |
| Waste water lagoon Zn | 30.2 | <1.0 | >97 |
| Waste water lagoon Cd | >252.9 | <1.3 | >99.5 |
| Waste water lagoon Tl | 60.2 | <0.6 | >99.6 |

In another aspect of the present invention there is provided a decontaminating system for removing contaminants or pollutants from an aqueous solution, wherein the system includes a decontaminating agent with which the aqueous solution is contacted, wherein the decontaminating agent is sapropel.

Preferably, the system includes means for contacting the aqueous solution with the decontaminating agent.

Further preferably, the sapropel is located within a filter.

Advantageously, the system includes three filters including sapropel and means for passing the aqueous solution through the three filters sequentially.

Preferably, the each filter is located within a separate tank.

Further preferably, the sapropel is mixed with a spacer such as bark or charcoal.

Advantageously, the system is provided with a layer of sapropel, through which the aqueous solution containing the pollutant or contaminants is passed.

Further preferably, if the contaminant includes heavy metal salts, the system is provided with sapropel which has a water content of 60% or below.

Preferably, if the pollutant or contaminant includes fine particles of precipitated metals and non-metals such as chrome, beryllium and arsenic, the system is provided with sapropel which has a water content of 60% or more.

Advantageously, if the contaminant or pollutant includes oil based water-dispersible liquids, such as soluble polycyclic aromatic hydrocarbons (PAHs) and polychlorobiphenyls (PCBs), the system is provided with sapropel which has a water content ranging between 80% to 95%.

Preferably, the aqueous solution containing the pollutant or contaminant has a pH falling within the range of 2.5 to 9.5.

Advantageously, the system includes means for agitating the sapropel.

Advantageously, the sapropel is located within a filter.

Preferably, the sapropel is arranged as a layer, which layer may be continuous or intermittent.

A number of non-limiting decontaminating systems in accordance with the present invention, will now be described by way of example and with reference to the accompanying Figures in which:

FIGS. 4A and 4B are a schematic diagram of a first embodiment of a decontaminating system in accordance with the present invention;

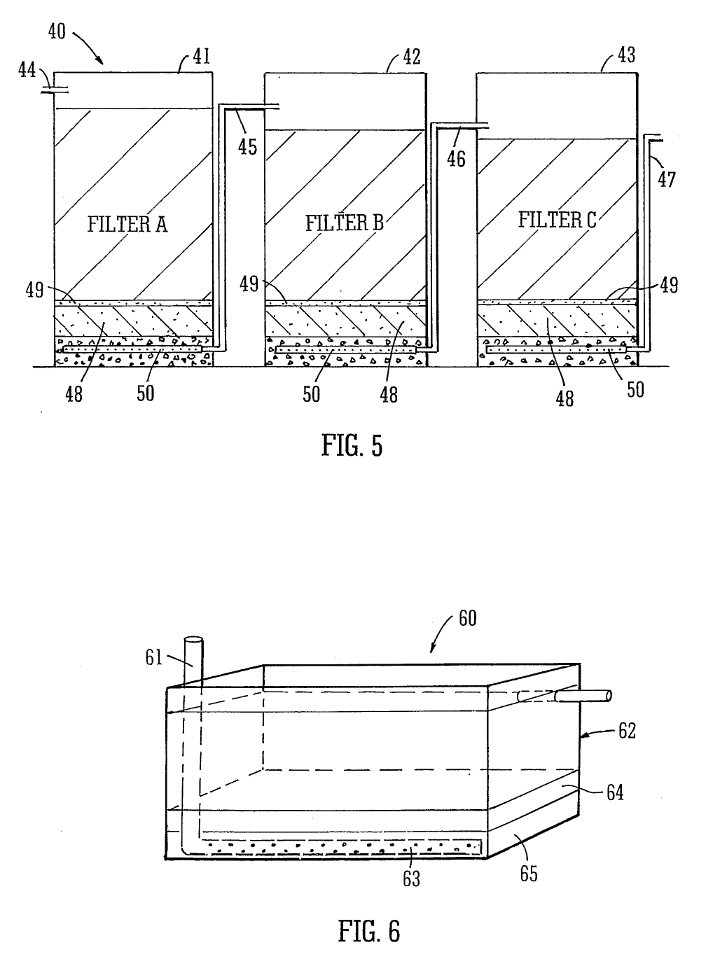

FIG. 5 is a schematic diagram of a first embodiment of a triple filter decontaminating system in accordance with the present invention;

FIG. 6 is a schematic diagram of a first embodiment of a passive decontaminating system in accordance with the present invention;

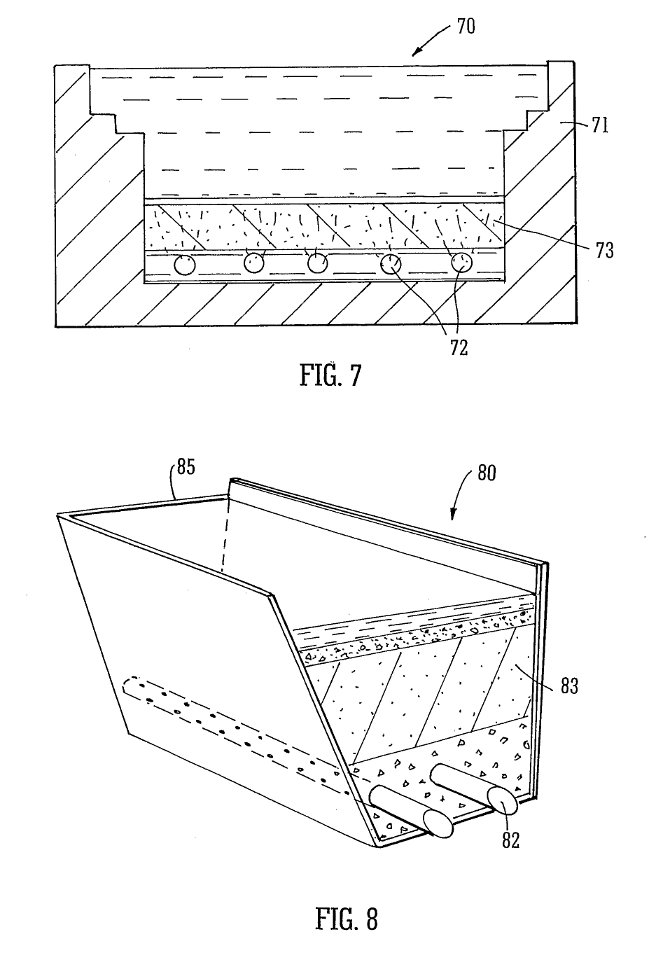

FIG. 7 is a schematic diagram of a second embodiment of a passive decontaminating system in accordance with the present invention;

FIG. 8 is a schematic diagram of a third embodiment of a passive decontaminating system in accordance with the present invention;

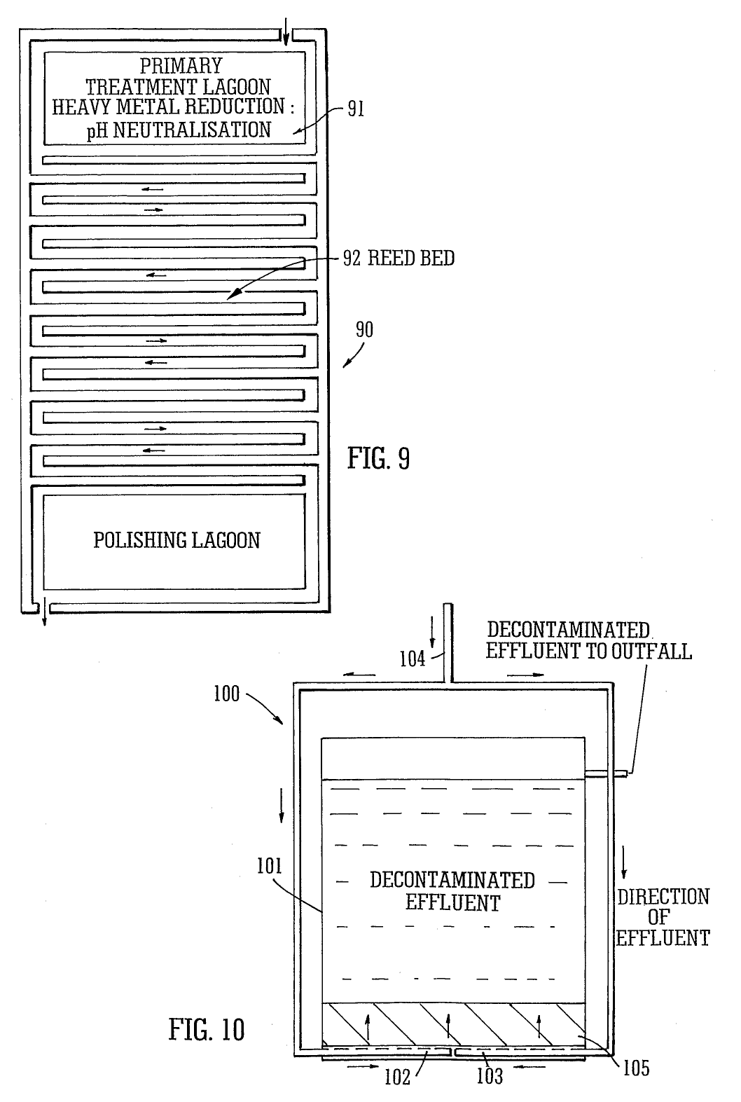

FIG. 9 is a schematic diagram of a fourth embodiment of a passive decontaminating system in accordance with the present invention;

FIG. 10 is a schematic diagram of a further decontaminating system in accordance with the present invention;

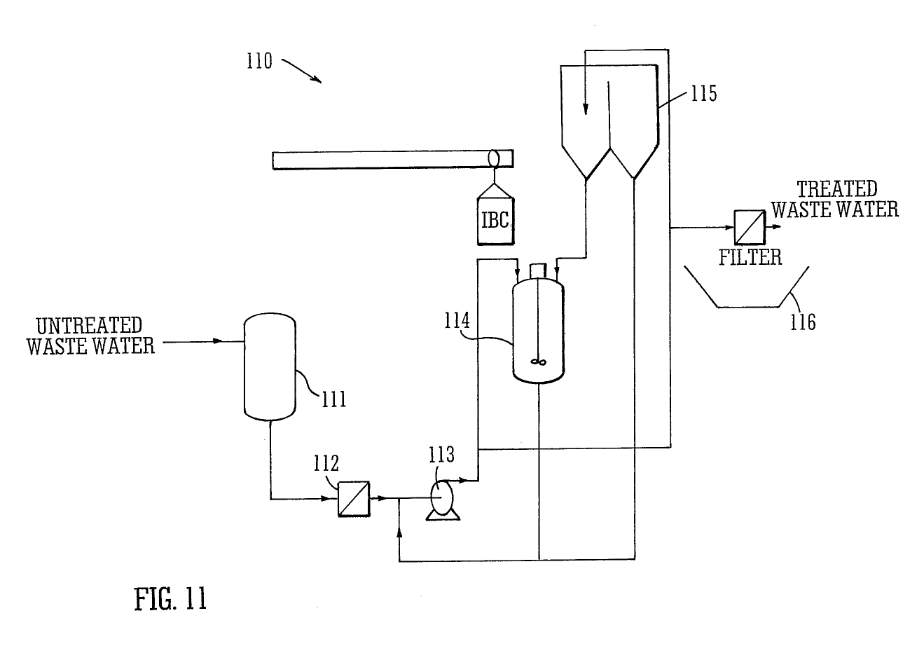

FIG. 11 is a schematic diagram of another decontaminating system in accordance with the present invention suitable for carrying out an agitation treatment process; and

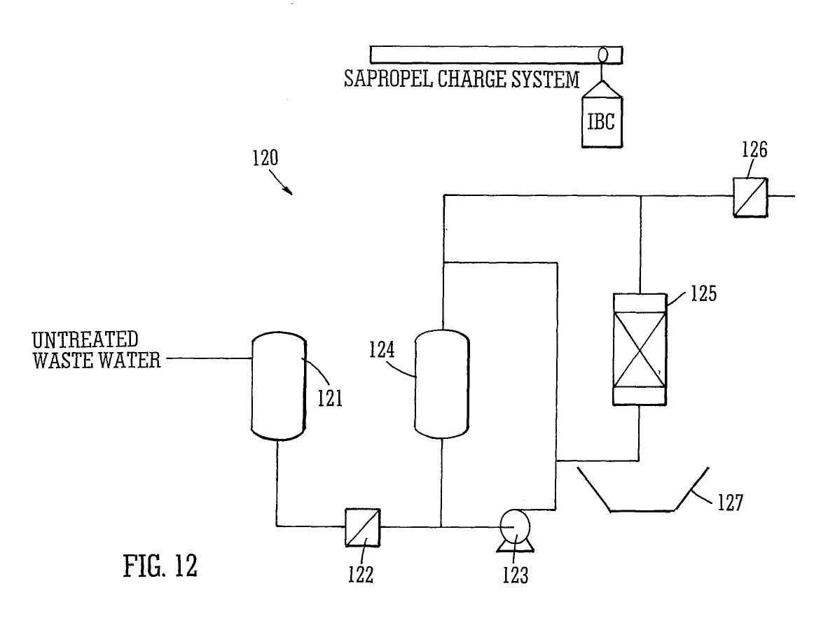

FIG. 12 is a schematic diagram of a further decontaminating system in accordance with the present invention.

As illustrated in FIGS. 4A and 4B, a first decontaminating system 30 in accordance with the present invention includes a fluid filled tank 35, within which is located a layer 31, which includes sapropel. The tank 35 has an inlet 32 and an outlet 33. In use, the aqueous solution containing the pollutants or contaminants is driven via the inlet through the layer 31 of sapropel. As shown in FIG. 4B, this results in the agitation or stirring up of the sapropel 31. As stated above, such agitation enhances the adsorption capabilities of the sapropel and increases the exposure of the adsorbing surfaces of the sapropel to the pollutants or contaminants. After a sufficient time the treated aqueous solution is removed from the tank 35 via the outlet 33. As will be appreciated, agitation can be effected by other means such as a stirrer or agitator blade (not illustrated).

As illustrated in FIG. 5, a first embodiment of an active decontaminating system 40, includes three tanks 41, 42 and 43 connected to one another in sequence by interconnecting pipes 45 and 46.

As shown, each tank 41, 42 and 43 is provided with a filter including a layer of sapropel 48, topped with a layer of gravel 49. Preferably, the layer of sapropel 48 includes a mix of forest bark and has a depth of approximately 150 mm. Further preferably, the layer of gravel 49 has a depth of 10 mm.

In use, effluent or an aqueous solution of contaminant or pollutant is fed through input 44 into the first tank 41, and by the action of gravity passes through the filter including sapropel 48. As will be appreciated, gravity flow is determined by differences in volume head. To this end, and for exemplary purposes only, the head difference between tanks 41 and 42 is 125 mm and the head difference between tanks 42 and 43 is 75 mm.

Each tank 41, 42 and 43 contains a basal bed of clean 10 mm gravel, embedded in which is a perforated land drain pipe 50. To this end, once the aqueous solution passes through the first filter 48 in the first tank 41, it will enter the land drain pipe and will pass into interconnecting pipe 45, where it is transported to the second tank 42 for further filtration. As above, once the filtrate exits the sapropel layer 48 provided in the second tank 42, it will enter the land drain pipe 50 and will pass into the third tank 43 via interconnecting pipe 46. To this end, once the aqueous solution passes through the sapropel layer 48 provided in the third tank 43, it then exits the decontaminating system 40 via outlet pipe 47.

Tabulated below is data from a trial utilising the above system and exemplifies the advantages of using a “series” system including at least two sapropel containing filters.

The trial involved the use of 3 filter beds in total, each containing 24.5 cm³ of dry sapropel, having a water content of about 40%, mixed with an equivalent volume of charcoal or forest bark to aid passage of the effluent through the Sapropel. Prior to contacting the effluent obtained from Britannia Zinc Smelter with sapropel, the system was primed with water from the mains to ensure a reasonable flow rate. The water/effluent was introduced into the first filter by means of a peristaltic pump flowing at 4 ml min⁻¹.

| | | | | | Equiv. |
|---|---|---|---|---|---|
| | | | | | bed vols |
| Measuring point | | Cd (ppm) | Pb (ppm) | Zn (ppm) | (ml) |
| Effluent untreated | | 4.2 | 1.1 | 26.1 | 0.0 |
| First filter | | | | | |
| 1 | litre passed | 0.1 | 0.0 | 1.9 | 40.0 |
| 2 | litres passed | 0.3 | 0.0 | 4.5 | 80.0 |
| 6 | litres passed | 0.5 | 0.0 | 6.0 | 240.0 |
| 10 | litres passed | 0.7 | 0.0 | 10.7 | 400.0 |
| 12 | litres passed | 0.8 | 0.0 | 10.0 | 480.0 |
| 14.7 | litres passed | 0.9 | 0.0 | 9.7 | 600.0 |
| 18.7 | litre passed | 1.2 | 0.0 | 10.3 | 762.0 |
| 20.6 | litres passed | 1.7 | 0.0 | 11.0 | 839.0 |
| 24.4 | litres passed | 1.6 | 0.0 | 11.6 | 994.6 |

Second filter

| | | | | | |
|---|---|---|---|---|---|
| 1 | litre passed | 0.0 | 0.0 | 0.1 | 40.0 |
| 2 | litres passed | 0.0 | 0.0 | 0.0 | 80.0 |
| 6 | litres passed | 0.0 | 0.0 | 0.0 | 240.0 |
| 10 | litres passed | 0.0 | 0.0 | 0.2 | 400.0 |
| 12 | litres passed | 0.0 | 0.0 | 1.4 | 480.0 |
| 14.7 | litres passed | 0.1 | 0.0 | 2.6 | 600.0 |
| 18.7 | litre passed | 0.0 | 0.0 | 1.5 | 762.0 |
| 20.6 | litres passed | 0.1 | 0.0 | 2.2 | 839.0 |
| 24.4 | litres passed | 0.1 | 0.0 | 2.6 | 994.6 |

Third filter

| | | | | | |
|---|---|---|---|---|---|
| 1 | litre passed | 0.0 | 0.0 | 0.0 | 40.0 |
| 2 | litres passed | 0.0 | 0.0 | 0.0 | 80.0 |
| 6 | litres passed | 0.0 | 0.1 | 0.0 | 240.0 |
| 10 | litres passed | 0.0 | 0.0 | 0.0 | 400.0 |
| 12 | litres passed | 0.0 | 0.1 | 0.0 | 480.0 |
| 14.7 | litres passed | 0.0 | 0.2 | 0.9 | 600.0 |
| 18.7 | litre passed | 0.1 | 0.5 | 1.8 | 762.0 |
| 20.6 | litres passed | 0.1 | 0.3 | 2.4 | 839.0 |
| 24.4 | litres passed | 0.1 | 0.3 | 1.8 | 994.6 |

As tabulated above, and by the use of a spectrophotometer, the primary untreated effluent contains a mixture of heavy metals including Zinc (Zn), Cadmium (Cd) and Lead (Pb). Once passed through the first filter, it is evident that the sapropel captured all of the lead and most of the zinc and cadmium. However, as more of the effluent is passed through, it is evident that cadmium and zinc are captured less efficiently. In this connection, it is postulated that this is the result of lead's affinity with organic matter within the sapropel matrix and its capability of forming complexes with silicon dioxide. Once passed through the second filter it is evident that there is still no lead and the cadmium is reduced to trace amounts. In addition, it can be seen that most of the Zinc has been removed. On passing through the final filter it is evident that only negligible amounts of the contaminants remain.

As illustrated in FIG. 6, a first embodiment of a passive decontaminating system 60 utilising the process in accordance with the present invention, is illustrated.

As illustrated, effluent is fed to the bottom of a reservoir 62 by means of a feed pipe 61, which is connected to a perforated land drain network 63 embedded in limestone scalpings 65.

The system 60 further includes a layer of sapropel 64 located on top of the limescale scalpings 65.

Effluent exiting the perforated land drain network 63 will disturb the sapropel layer 64; this enhances contact of the sapropel 64 with the contaminant or pollutants, for example, heavy metal cations.

On passing through the sapropel 64, it will be appreciated that the aqueous solution which accumulates in the reservoir 62 will contain far fewer heavy metal cations.

It is to be appreciated that the system of FIG. 6 can be coupled to an active filtration system of the type illustrated in FIG. 4 or 5 and/or coupled to passive decontaminating reed bed of the type illustrated in FIG. 9.

With reference to FIG. 7, a passive decontamination system 70 is incorporated within a lagoon, reservoir or lake 71, or other like body of water. As will be appreciated, this system 70 is suitable for large scale applications, for example, applications involving the treatment of greater than 100 m³ day⁻¹ of aqueous solution of contaminants or pollutants.

Effluent is fed into the lake 71 by means of several perforated drainpipes 72, each being embedded within limestone scalpings.

As above, the effluent is forced up through a layer of neat sapropel 73 such that the heavy metals or other contaminants it is carrying is retained by the sapropel layer 73.

As above, the filtrate can be further treated by feeding water from the lake 71 into another active filtration system in accordance with the present invention, for example, that of FIG. 4 or 5.

A further embodiment of a passive decontamination system 80 in accordance with the present invention is illustrated in FIG. 8.

The passive decontamination of FIG. 8 includes a reed bed 85 charged with a layer of sapropel 83. Preferably, the bed 85 is in the form of a channel or rhine. The channel or bed 85 is lined with an impermeable membrane, such as butyl. Perforated land pipes 82 are embedded in clean river gravel and a neat layer of sapropel 83 is deposited over the gravel. This layer of sapropel 83 is covered with a further layer of gravel, for example, a limestone shingle layer. Reeds may be planted in the sapropel and anchored within this gravel layer.

As above, effluent is forced upwards through the sapropel layer 83 via the perforated pipes 82 such that the pollutants or contaminants it is carrying is retained by the sapropel layer 83.

As illustrated in FIG. 9, the system described in FIG. 9 can be used to link other decontaminating systems.

As illustrated in FIG. 9, a further decontaminating system 90 includes a primary treatment lagoon, lake, dam or reservoir 91 of the type described in either of FIG. 6, 7 or 8. The treated filtrate or effluent exiting the lagoon, lake, dam or reservoir 91 is passed through reed beds 92, for example, of the type described in FIG. 8. After being treated by the reed beds 92, water or filtrate then enters a final lagoon of the type of FIG. 6 or FIG. 7 such that the water leaving the final lagoon can then enter the watercourse.

As illustrated in FIG. 10, the decontaminating system 100, includes a tank 101 which is set up with waste water entering through two inlets 102, 103 diametrically opposite each other. The internal tank distribution pipe work 104 is split into two halves such that each inlet serves one half of the original distribution pipe work. The feed into the tank 101 is modified so water enters at the bottom rather than at the top such that it passes through the layer of sapropel 105.

The following results were achieved utilising the system of FIG. 10:

| | |
|---|---|
| Average instantaneous flow - | 4.6 l/min |
| Average daily flow - | 6.7 m³/day |

| | Zinc (mg/l) | Lead (mg/l) | Cadmium (mg/l) |
|---|---|---|---|
| Feed out of tank A | 2.5 | 1.3 | 1.0 |
| Outlet of tank B | 1.2 | 0.6 | 0.4 |
| Outlet of tank C | 0.2 | 0.1 | 0.04 |
| Consent | 0.9 | 0.3 | 0.2 |

As can be seen, the above demonstrates that consent discharge levels could be achieved utilising the system of FIG. 10.

FIG. 11 illustrates an embodiment of the invention whereby the process of ion capture is speeded up using mechanical agitation of the sapropel/effluent mix.

As illustrated, untreated waste water is collected in a buffer tank 111 and fed through an in line filter 112 to a pump 113, which in turn charges a pre determined amount of waste water into an agitated vessel 114. A predetermined amount of sapropel is charged to the agitated vessel 114 and agitated for about 30 minutes. The mix of sapropel and waste water is then pumped to a separation tank 115, where the sapropel is allowed to settle. Sapropel from the separation tank 115 is recycled to the agitated vessel 114. Treated water from the separation tank 115 is filtered before discharge. Spent sapropel is filtered from the treated water and dumped from the filter into a collection tank 116. The spent sapropel is allowed to dry before subsequent disposal.

A series of trials at two scales were completed, one with a 401 vessel and the other with a 10001 vessel. Results from the two series of trials were similar indicating the scale up to be close to linear. Sapropel ratios to waste water in the range 1:20 to 1:30 were found to achieve consent in the range 15 to 60 min. respectively.

| | Zinc | Lead | Cadmium |
|---|---|---|---|
| Consent(mg/l) | 0.9 | 0.3 | 0.2 |
| Ratio 30:1 | | | |
| Feed(mg/l) | 6 | 0.5 | 1.3 |
| 60 min(mg/l) | 0.7 | 0.1 | 0.2 |
| Ratio 20:1 | | | |
| Feed(mg/l) | 10 | 0.44 | 1.8 |
| 15 min(mg/l) | 0.77 | 0.09 | 0.13 |

FIG. 12 relates to an embodiment of the invention 120 whereby the effluent is pumped through a packed column of sapropel.

As illustrated, untreated waste water is collected in a buffer tank 121 and fed through an in line filter 122 to a pump 123, which in turn charges a predetermined amount of waste water into a feed/recycle tank 124. The contents of the feed vessel 124 are pumped through a column 125 packed with sapropel and recycled to the feed vessel 124 until the required removal of metals has been achieved. At this point the treated water is fed through a filter 126 prior to discharge. The spent sapropel can be collected in a collection tank 127.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A decontamination process comprising the step of contacting an aqueous solution containing a pollutant or contaminant with a decontaminating agent, wherein the decontaminating agent is sapropel.

2. The process of claim 1, wherein the sapropel has a water content of about 90% or below, preferably about 80% or below, more preferably 80% or below, further preferably about 15% or below.

3. The process of claim 2, wherein the sapropel has a water content of 40%.

4. The process of claim 1, wherein the sapropel is ground and dried prior to use as a decontaminating agent.

5. The process of claim 1, wherein the aqueous solution containing the pollutant or contaminant is passed through at least one filter which includes sapropel, preferably two sapropel containing filters, more preferably three sapropel containing filters.

6. The process of claim 1, wherein the aqueous solution containing the pollutant or contaminant is passed through at least one layer of sapropel.

7. The process of claim 1, wherein the sapropel is agitated prior to or on contact with the pollutants or contaminants.

8. The process of claim 1, in which when the contaminant includes heavy metal salts, the sapropel has a water content of 60% or below.

9. The process of claim 1, in which when the pollutant or contaminant includes fine particles of precipitated metals and non-metals such as chrome, beryllium and arsenic, the sapropel has a water content of 60% or more.

10. The process of claim 1, in which when the contaminant or pollutant includes oil based water-dispersible liquids, such as soluble polycyclic aromatic hydrocarbons (PAHs) and polychlorobiphenyls (PCBs), the sapropel has a water content ranging between 80% to 95%.

11. The process of claim 1, wherein the aqueous solution containing the pollutant or contaminant has a pH falling within the range of 2.5 to 9.5.

12. The process of claim 1, further including the step of removing any surfactants or other coating agents prior to contacting the aqueous solution with the sapropel.

13. The process of claim 1, wherein the sapropel is mixed with a spacer, such as shredded wood bark or charcoal.

14. A decontaminating system for removing contaminants or pollutants from an aqueous solution, wherein the system includes a decontaminating agent with which the aqueous solution is contacted, wherein the decontaminating agent is sapropel.

15. The system of claim 14, wherein the system includes means for contacting the aqueous solution with the decontaminating agent.

16. The system of claim 14, wherein the sapropel is located within a filter.

17. The system of claim 16, wherein the system includes three filters including sapropel and means for passing the aqueous solution through the three filters sequentially.

18. The system of claim 16, wherein each filter is located within a separate tank.

19. The system of claim 14, wherein the sapropel is mixed with a spacer such as bark or charcoal.

20. The system of claim 14, which is provided with a layer of sapropel, through which the aqueous solution containing the pollutant or contaminants is passed.

21. The system of claim 14, in which when the contaminant includes heavy metal salts, the system is provided with sapropel which has a water content of 60% or below.

22. The system of claim 14, in which when the pollutant or contaminant includes fine particles of precipitated metals and non-metals such as chrome, beryllium and arsenic, the system is provided with sapropel which has a water content of 60% or more.

23. The system of claim 14, in which when the contaminant or pollutant includes oil based water-dispersible liquids, such as soluble polycyclic aromatic hydrocarbons (PAHs) and polychlorobiphenyls (PCBs), the system is provided with sapropel which has a water content ranging between 80% to 95%.

24. The system of claim 14, wherein the aqueous solution containing the pollutant or contaminant has a pH falling within the range of 2.5 to 9.5.

25. The system of claim 14, wherein the system includes means for agitating the sapropel.

26-29. (canceled)
